(19) United States
(12) Patent Application Publication
(10) Pub. No.: US 2002/0116161 A1
(43) Pub. Date: Aug. 22, 2002

(54) Functional requirement-based knowledge-engineered process for substation design

(76) Inventors: Lavelle Freeman, Garner, NC (US); Lan H. Trinh, Raleigh, NC (US); Krassimir Koutlev, Cary, NC (US); Jiuping Pan, Raleigh, NC (US); Peter Bosshart, Wohlen (CH)

Correspondence Address: Susan C. Murphy, Esq., Woodcock Washburn Kurtz, Mackiewicz & Norris LLP, One Liberty Place - 46th Floor, Philadelphia, PA, 19103, US

(21) Appl. No.: 09/750,574

(22) Filed: Dec. 28, 2000

(51) Int. Cl. G06F 17/50

(52) U.S. Cl. 703/13

(57) ABSTRACT

The disclosed invention provides computer-implemented systems and methods for designing a power substation. The inventive method includes identifying functional requirements for the power substation and generating at least one substation design satisfying the functional requirements from a library of substation components. Additionally, functional preferences are identified and used to rank the generated substation designs.

### TECHNICAL FIELD

This invention relates to the field of software design tools. In particular, the invention is directed to a software system for designing electrical power substations and switching substations.

### BACKGROUND

The planning and design of an electric power system is a highly knowledge-intensive process that draws on numerous areas of expertise from a wide body of disciplines. The process invariably involves steps like data collection, analysis and simulations, and the application of numerous heuristic rules from an extensive knowledge base. The integration of all these activities into the design process requires specialized knowledge. This kind of knowledge is not found in any single document or well-recognized collection of sources, but is widely dispersed. Much of it resides only in the minds of human experts.

Increasingly, companies are beginning to recognize the value of knowledge engineering as a means of retaining and documenting valuable expertise. Advantages to such a system include: reliable performance, use as a training or diagnostic tool, reduction of design effort, knowledge retention and aggregation, providing a starting point for human experts or serving as a double-check, providing a basis for agreement between customer and supplier, and prompting experts to rethink solutions to old problems.

Although the application of knowledge-based tools to electric power system engineering is not a new idea, such systems have been more frequently applied to the areas of intelligent alarm processing, system diagnosis and operation. The substation design tools that are available start with a solution set of pre-existing, proven system designs to which modifications are suggested, limiting the universe of potential design solutions. In the past, input to a design system frequently was a set of detailed specifications based on a legacy or pre-existing system, rather than a set of functional requirements from the customer. Additionally, no scaling function was available to rate how well the design matched the functional requirements of the user.

A need for change is evident, compounded by the recent deregulation of the power industry. Deregulation has opened the power industry to entities other than traditional public utilities. Present day substation customers may not have a large engineering department, or a legacy system from which to draw a set of detailed specifications. Hence, a need exists in the art to automate the process of substation conceptual design, starting with a set of the customer's functional requirements.

### SUMMARY OF THE INVENTION

The invention provides a way to simplify the process of developing a design of a electrical power substation or switching substation. Functional requirements are collected by a computerized system, which analyzes the functional requirements and generates a set of possible designs from a library of substation components and subsystems that meets those functional requirements.

The substation design system also may solicit information regarding preferences concerning aspects of the substation from which weighted preference values may be generated for those aspects. Aspects may include but are not limited to flexibility of operation of the substation, the environmental impact of the substation, the cost of the substation and the reliability of the substation. The generated designs may then be ranked as to how well the design meets the weighted preferences.

### BRIEF DESCRIPTION OF THE DRAWINGS

The invention is further described in the detailed description that follows, by reference to the noted plurality of drawings by way of non-limiting examples of preferred embodiments of the invention, in which like reference numerals represent similar parts throughout the several views of the drawings, and wherein:

FIG. 1 is a functional flow chart of the substation design system;

FIG. 2 is a flow chart of the substation design system;

FIG. 3 illustrates an exemplary computing environment in accordance with the invention; and

FIG. 4 illustrates an exemplary network environment in accordance with the invention.

### DETAILED DESCRIPTION OF THE PREFERRED EMBODIMENTS

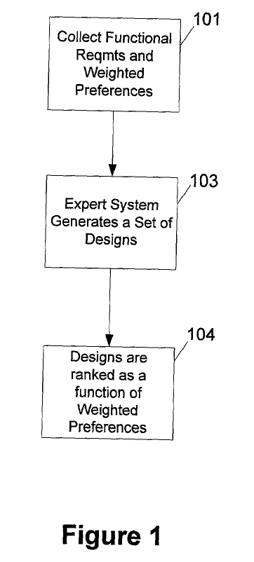

The invention discloses a functional requirement-based process for substation design. The disclosed invention enables the generation of designs for power substations and switching substations. A power substation typically provides or supplies power to customers. A power substation, in addition to performing a supply function, may in addition, transfer power to other substations and power stations. A switching substation typically transfers high voltage power to other substations or power stations (the transfer function). Referring now to FIG. 1, at step 101 an input function collects functional requirements and weighted preferences. At step 103 a set of designs meeting the functional requirements are generated by an expert system using a library or database of substation components (not shown) and the functional requirements collected at step 101. At step 104 the designs generated at step 103 are analyzed and ranked according to the weighted preferences collected at step 101.

Functional requirements collected at step 101 include information including but not limited to initial constraints of the desired substation to be designed. Functional requirements include the minimum information that an expert would need from a customer to produce a design that best meets the customer's needs, without providing so many constraints that a sub-optimal design is produced. Non-limiting examples of functional requirements may include such information as: how much land the customer has on which the substation is to be built, system voltage required, system capacity required, what size load the customers will carry if the substation will carry a load, what size substation is required, whether the substation is a power or a switching substation and what initial boundary conditions exist (for example, load of incoming lines, existing environmental conditions and restrictions such as “no overhead power lines are permitted in the area”).

To avoid predefining technical solutions, parameters for all terminals of the substation needed for the energy supply and/or transfer task during normal operation, fault conditions and station split-up condition are assigned. During normal operation the substation is operating within normal parameters. Fault conditions occur when power is interrupted because, for example, a critical component failure disrupts the energy transfer function and power supply to customers is interrupted. Station split-up or revision refers to reconfiguring the substation so that, for example, if a substation has several bus sections and transformers, then under fault conditions or scheduled maintenance, the substation can be “split-up” to minimize the impact on customers.

Penalties due to unavailability of energy supply and/or transfer tasks can affect design decisions. Hence, expectation values defining the maximum tolerated outage frequency and outage duration of energy supply and/or transfer tasks for any station-based outages, such as faults or maintenance are also collected at step 101.

Parameters are assigned based on expert interviews, project records and publications such as design handbooks, papers and standards. From this set of specifications, questions are constructed to solicit the necessary data for the customer functional requirements.

Weighted preferences are also collected at step 101. Alternately, data or information may be collected from which weighted preferences may be calculated. Weighted preferences include “soft” requirements or preferences, which are weighted as to the importance of the “soft” requirements to the customer. These weights represent the relative value that a customer places on attributes or aspects of the desired substation. Non-limiting examples of preference requirements include factors such as reliability, cost flexibility and environmental impact and aesthetics of the desired substation. For example, weighted preferences may specify that of the total (100%), a 40% weight should be allocated to cost, 40% to reliability, 20% to environmental concerns and 0% to flexibility.

At step 103 an expert system generates a set of possible design alternatives for substations, the generated designs meeting the functional requirements collected in step 101. The expert system contains an inference engine that simulates a human expert's reasoning process with a series of if-then rules and procedures. The rules and procedures are selected and configured to generate design alternatives that will satisfy the functional requirements gathered at step 101. The expert system includes an expert system shell as is well-known in the art, consisting of an artificial intelligence (AI) based representation of the decision hierarchy represented as a decision tree defined by hierarchical nodes. The expert system may be any of a number of expert system shells or languages including but not limited to the following: Babylon, CLIPS, ESIE, Frulekit, OPS5, Prolog, Visual Rules Studio, NEXPERT OBJECT and Agent OCX. In an exemplary embodiment Agent OCX is used although it should be understood that any suitable expert system could be used.

A set of feasible design alternatives (not shown) which satisfy the customer's functional requirements is generated by the expert system. A power substation typically can be divided into five major components or subsystems: incoming lines, primary busbar, transformers, secondary busbar, and outgoing lines. A switching substation typically can be divided into 3 major components or subsystems: incoming lines, primary busbar and outgoing lines. The expert system generates possible designs by selecting an option for each of the components needed for the substation that meets the functional requirements collected in step 101. In this way, the substation can dynamically be configured by the expert system to satisfy functional requirements collected at step 101. The expert system of step 103 may be modified and added to. It should be understood that although software system employed at step 103 is designated an expert system, the use of any appropriate software system could be employed without departing from the spirit and scope of the invention.

Multi-criteria analysis at step 104 can be used to rank possible substation designs generated by expert system at step 103 with respect to weighted preferences collected at step 101. Weighted preferences collected at step 101 are used to compute a design score (DS) for each generated solution using attribute relative scores (S) assigned to each element or substation component in a reference library for each of the N preference categories including but not limited to flexibility, cost, reliability and environmental impact and weight (W) from weighted preferences collected in step 101. The design score for the generated design is calculated by the formula:

$$D S = {\sum }_{i = 1}^{N} ( {W}_{i} * {S}_{i} )$$

The alternative designs are then ranked by design score at step 104. The highest ranking alternative is the one that best satisfies the customer's functional requirements and design/performance preferences.

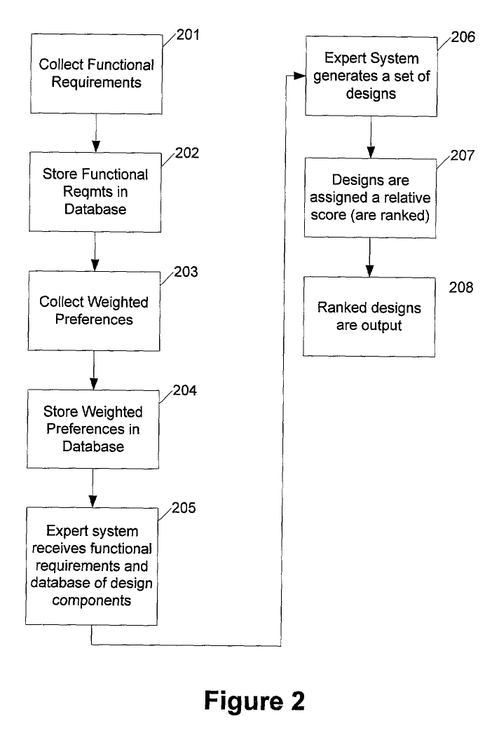

Referring now to FIG. 2, a more detailed description of the substation design process is illustrated. As can be seen from FIG. 2, at step 201, and as described above, functional requirements are collected. Functional requirements are collected by an interactive graphical user interface. Functional requirements are collected by interactively presenting questions in a logical, hierarchical manner and accepting and saving responses in a functional requirements database. Depending on a user's responses, the program presents follow-up questions, eliminating irrelevant and unnecessary questions through the use of a decision tree as well known in the art.

At step 202 functional requirements as collected in step 201 are stored in a functional requirements database.

At step 203 weighted preferences or information to generate weighted preferences as described above are collected, using the interactive graphical user interface described above. At step 204 weighted preferences are stored in a weighted preference database in step 202. It should be understood that functional requirements database and weighted preference database may be combined into a single database without departing from the spirit and scope of the invention and that questions directed to eliciting weighted preference information may be interspersed with questions directed to eliciting functional requirements information and vice versa without departing from the spirit and scope of the invention.

At step 205 an expert system as described above receives information from the functional requirements database created in step 202. In addition at step 205 the expert system receives a database of substation designs and components which is the solution space from which components will be drawn that satisfy the needs of the customer as defined by the functional requirements collected at step 201. The database includes a collection of subsystems from which to draw components that satisfy functional requirements collected at step 201.

The database of substation designs and components and attributes thereof can be added to and modified. Each component in the database may have a number of options associated with the component. For example, the options of the primary busbar component are the commonly used primary side configurations including but not limited to: split single bus, double-bus double breaker, breaker and one half, and ring bus.

The database of substation designs and components includes data for a plurality of designs, the data including but not limited to the number of transformers, number of primary and secondary circuits and component layout. In addition, attribute relative scores (S) are assigned to each element or substation component in the database for each of the preference categories including but not limited to relative reliability, relative flexibility, normalized cost (capital, outage and maintenance, life cycle) and relative impact on the environment including but not limited to aesthetic, audible noise, and pollution. A substation reliability assessment program can be used to assess the reliability of the designs. Design handbooks, expert surveys, technical papers, and project records can be used to gather information about the cost, reliability, flexibility and environmental impact of the various designs and components including but not limited to breakers, switches and transformers. For designs not archived in the reference library, an analytical scaling formula can be developed to compute the relative scores for the required design from the nearest available design in the database. This score may be a function of the number of transformers, number of circuits, number and type of breakers and other parameters. At step 205 functional requirements collected at step 201 and stored in a database at step 202 and the database described above is received by an expert system as described above. At step 206 the expert system generates a set of substation design alternatives. At step 207 the set of substation designs generated by each substation design generated at step 205 by the expert system is assigned a relative score, representing how well the design satisfies the weighted preferences collected at step 203 and stored in weighted preferences database at step 204. A relative score is assigned to each design according to the formula:

$$DS = {\sum }_{i = 1}^{N} ( {W}_{i} * {S}_{i} )$$

described above, wherein the generated designs are evaluated as a function of how well the design meets the preference-driven attributes including but not limited to cost, reliability, flexibility and environmental impact collected at step 203 and stored in weighted preferences database at step 204.

At step 208 the ranked designs are output as substation design diagrams. The form of the output may be a report or diagram or may be stored on a computer-readable medium without departing from the spirit and scope of the invention.

Illustrative Computing Environment

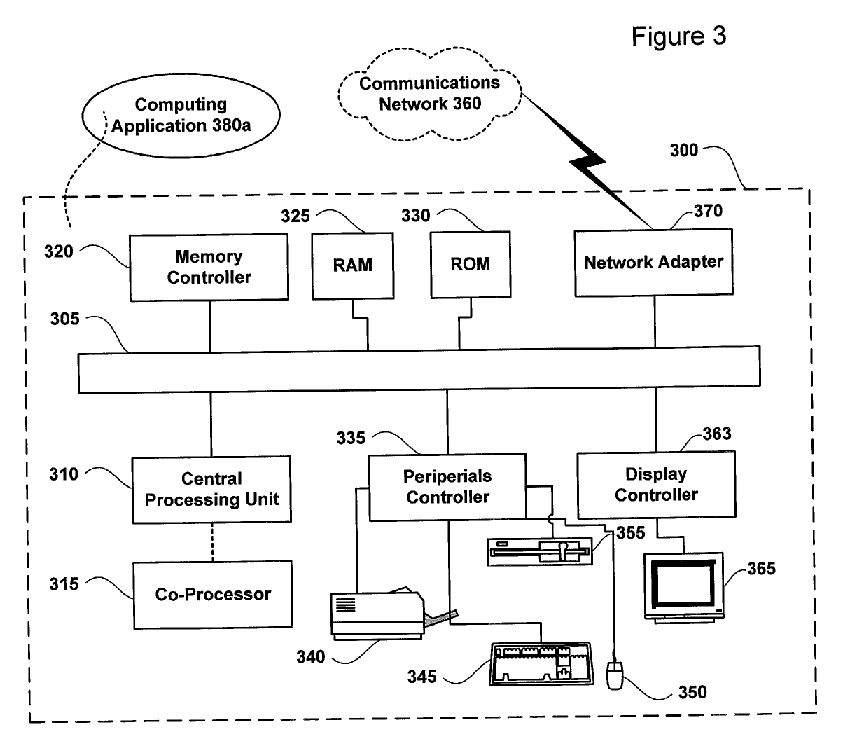

The above designed system may be implemented in a number of computing environments of which the following description is one. FIG. 3 depicts an exemplary computing system 300 in accordance with the invention. Computing system 300 is capable of executing an exemplary substation design computing application 380a that creates a set of substation designs based on functional requirements. Exemplary computing system 300 is controlled primarily by computer readable instructions, which may be in the form of software, wherever, or by whatever means such software is stored or accessed. Such software may be executed within central processing unit (CPU) 310 to cause data processing system 300 to do work. In many known workstations and personal computers central processing unit 310 is implemented by a single-chip CPU called a microprocessor. Coprocessor 315 is an optional processor, distinct from main CPU 310, that performs additional functions or assists CPU 310. One common type of coprocessor is the floating-point coprocessor, also called a numeric or math coprocessor, which is designed to perform numeric calculations faster and better than general-purpose CPU 310. Recently, however, the functions of many coprocessors have been incorporated into more powerful single-chip microprocessors.

In operation, CPU 310 fetches, decodes, and executes instructions, and transfers information to and from other resources via the computer's main data-transfer path, system bus 305. Such a system bus connects the components in computing system 300 and defines the medium for data exchange. System bus 305 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 310. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 305 include random access memory (RAM) 325 and read only memory (ROM) 330. Such memories include circuitry that allows information to be stored and retrieved. ROMs 330 generally contain stored data that cannot be modified. Data stored in RAM 325 can be read or changed by CPU 310 or other hardware devices. Access to RAM 325 and/or ROM 330 may be controlled by memory controller 320. Memory controller 320 may provide an address translation function that translates virtual addresses into physical addresses as instructions are executed. Memory controller 320 may also provide a memory protection function that isolates processes within the system and isolates system processes from user processes. Thus, a program running in user mode can access only memory mapped by its own process virtual address space; it cannot access memory within another process's virtual address space unless memory sharing between the processes has been set up.

In addition, computing system 300 may contain peripherals controller 335 responsible for communicating instructions from CPU 310 to peripherals, such as, printer 340, keyboard 345, mouse 350, and disk drive 355.

Display 365, which is controlled by display controller 360, is used to display visual output generated by computing system 300. Such visual output may include text, graphics, animated graphics, and video. Display 365 may be implemented with a CRT-based video display, an LCD-based flat-panel display, gas plasma-based flat-panel display, or a touch-panel. Display controller 363 includes electronic components required to generate a video signal that is sent to display 365.

Further, computing system 300 may contain network adaptor 370 which may be used to connect computing system 300 to an external communication network 360. Communications network 360 may provide computer users with means of communicating and transferring software and information electronically. Additionally, communications network 360 may provide distributed processing, which involves several computers and the sharing of workloads or cooperative efforts in performing a task. It will be appreciated that the network connections shown are exemplary and other means of establishing a communications link between the computers may be used. It should be understood that the systems and methods for designing substations in accordance with the present invention can be implemented with a variety of computer architectures and thus should not be limited to the example shown.

Illustrative Computer Network Environment For Designing Substations

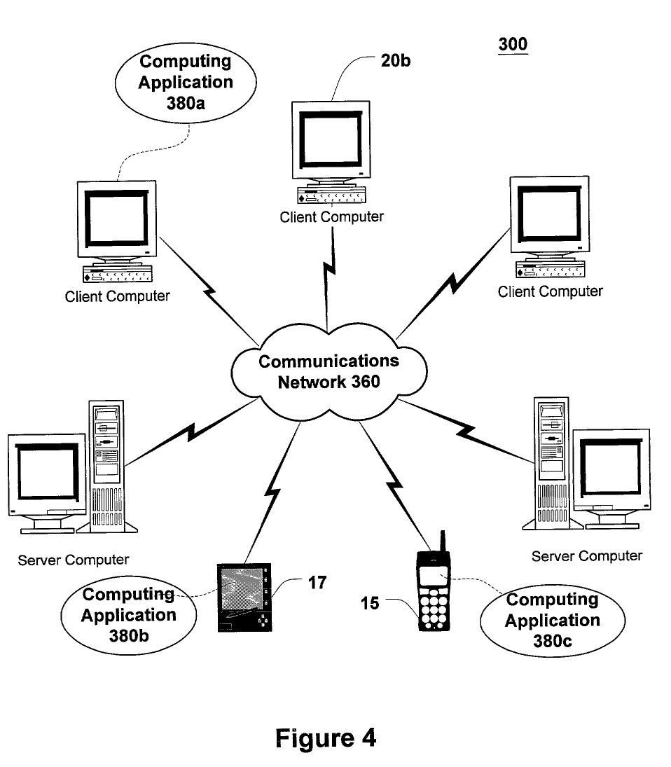

As noted above, the computer described with respect to FIG. 3 can be deployed as part of a computer network. In general, the above description applies to both server computers and client computers deployed in a network environment. FIG. 4 illustrates an exemplary network environment, with a server computer 10a, 10b in communication with client computers 20a, 20b, 20c via a communications network 360, in which the present invention may be employed. As shown in FIG. 4, a number of servers 10a, 10b, etc., are interconnected via a communications network 360 (which may be a LAN, WAN, intranet or the Internet) with a number of client computers 20a, 20b, 20c, or computing devices, such as, mobile phone 15 and personal digital assistant 17. In a network environment in which the communications network 360 is the Internet, for example, the servers 10 can be Web servers with which the clients 20 communicate via any of a number of known protocols, such as, hypertext transfer protocol (HTTP) or wireless application protocol (WAP), as well as other innovative communication protocols. Each client computer 20 can be equipped with computing application 380a to gain access to the servers 10. Similarly, personal digital assistant 17 can be equipped with computing application 380b and mobile phone 15 can be equipped with computing application 380c to display and receive various data.

The invention can be utilized in a computer network environment having client computing devices for accessing and interacting with the network and a server computer for interacting with client computers. However, the systems and methods for providing substation design in accordance with the disclosed invention can be implemented with a variety of network-based architectures, and thus should not be limited to the example shown.

Thus systems and methods for a computer-implemented design tool are disclosed in which a set of functional requirements and preferences are collected, a database of substation components is created and an expert system generates a set including at least one substation design. The set of designs is analyzed and ranked against a set of weighted preferences.

What is claimed is:

1. A computer-implemented method for designing an electrical substation, comprising:
identifying functional requirements for said electrical substation;
selecting components for said electrical substation from a store of said components as a function of said functional requirements; and
generating at least one substation design, said substation design meeting said identified functional requirements for said electrical substation.

2. The computer-implemented method of claim 1, further comprising:
receiving data concerning weighted preferences regarding aspects of said substation; and
ranking said substation design as a function of said preferences.

3. The computer-implemented method of claim 1, further comprising outputting at least one of said substation designs.

4. The computer-implemented method of claim 1, wherein an electrical substation comprises one of a power substation and a switching substation.

5. The computer-implemented method of claim 1, wherein identifying functional requirements for said electrical substation further comprises:
presenting a series of questions; and
accepting responses to said questions;
wherein subsequent questions are presented as a function of responses to previous questions.

6. The computer-implemented method of claim 1, wherein said generating at least one substation design comprises using a knowledge-based system that includes a user modifiable artificial intelligence based representation of a decision tree defined by hierarchical nodes.

7. The computer-implemented method of claim 1, wherein selecting components for said electrical substation design further comprises creating a database including a stored database representation of attributes of substation components, said stored database representation being consistent with the multi-level nodal hierarchy of the knowledge-based system.

8. The computer-implemented method of claim 7, wherein said database can be dynamically updated with additional designs and substation components and component attributes.

9. A computer-implemented system for designing an electrical substation comprising:
an input device for collecting functional requirements for an electrical substation;
a processing unit containing computer-executable instructions for accepting said functional requirements for an electrical substation and for generating at least one design for an electrical substation as a function of said functional requirements.

10. The computer-implemented system of claim 9, further comprising an output device, for outputting said at least one design for an electrical substation as a function of said functional requirements.

11. The computer-implemented system of claim 9, wherein said computer-executable instructions for generating at least one design for an electrical substation as a function of said functional requirements further comprises computer-executable instructions for accepting weighted preferences regarding aspects of said substation and ranking at least one said design for said electrical substation as a function of said preferences.

12. The computer-implemented system of claim 9, wherein said input device for collecting functional requirements for an electrical substation further comprises an input device for collecting information from which weighted preferences can be derived.

13. The computer-implemented system of claim 9, wherein said input device for collecting functional requirements presents questions in an interactive, hierarchical manner, wherein subsequent questions are presented as a function of responses to previous questions.

14. The computer-implemented system of claim 13, wherein said system of presenting questions is implemented by means of a decision tree.

15. The computer-implemented system of claim 9, wherein said processing unit for generating at least one substation design as a function of said functional requirements is an expert system.

16. The computer-implemented system of claim 9, wherein said processing unit for generating at least one substation design further comprises executable instructions for ranking said at least one substation design as a function of weighted preferences.

17. The computer-implemented system of claim 10, wherein said output device further comprises a device for outputting a list of system components making up a substation design and their attributes.

18. The computer-implemented system of claim 10, wherein said output device further comprises a device for outputting a blueprint of a substation design.

19. A computer-readable medium containing computer-executable instructions for designing an electrical substation comprising:
identifying functional requirements for said electrical substation;
selecting components for said electrical substation from a store of said components as a function of said functional requirements; and
generating at least one substation design, said substation design meeting said identified functional requirements for said electrical substation.

20. The computer-readable medium of claim 19, containing further computer-executable instructions for designing an electrical substation for:
identifying preferences; and
ranking said at least one substation design as a function of said preferences.

21. The computer-readable medium of claim 19, wherein said computer-executable instructions for generating at least one design further comprise a knowledge-based system including a user-modifiable artificial intelligence.

22. The computer-readable medium of claim 19, wherein said computer-executable instructions further comprise instructions for evaluating said design solution, using an input of preferences.

23. The computer-readable medium of claim 19, wherein the computer-executable instructions define a multi-level, nodal decision tree defined by hierarchical nodes.

24. The computer-readable medium of claim 19, wherein said instructions include a database of substation components consistent with said knowledge based system.

25. The computer-readable medium of claim 19, containing further computer-executable instructions for developing a database of substation components.
